(19) United States
(12) Patent Application Publication
(10) Pub. No.: US 2017/0259099 A1
(43) Pub. Date: Sep. 14, 2017

(54) SILICON-CONTAINING ORGANIC ACID DERIVATIVES AS ENVIRONMENTALLY FRIENDLY AFFF EXTINGUISHING AGENTS

(71) Applicant: UNIVERSITÄT ZU KÖLN, Köln (DE)

(72) Inventors: Dirk BLUNK, Hürth (DE); Shute YE, Köln (DE); Ralf Helmut HETZER, Wietzendorf (DE); Hanna SEBODE, Köln (DE); Richard Daniel MEISENHEIMER, Köln (DE)

(21) Appl. No.: 15/508,865

(22) PCT Filed: Sep. 2, 2015
(86) PCT No.: PCT/EP2015/070046

§ 371 Date: Mar. 3, 2017

(30) Foreign Application Priority Data
Sep. 5, 2014 (DE) 102014112851.6

(51) Int. Cl. A62D 1/02; A62C 99/00

(52) U.S. Cl. CPC A62D 1/0071; A62C 99/0036

(57) ABSTRACT

The invention relates to a fire fighting foam concentrate comprising a first surfactant, the first surfactant having an acid group as well as an oligosilane unit and/or oligosiloxane unit. The invention further relates to a method for extinguishing fires, comprising the steps of: providing a fire fighting foam concentrate; adding the fire fighting foam concentrate to water to obtain a mixture and bringing the fire into contact with the mixture; wherein the fire fighting foam concentrate is a fire fighting foam concentrate according to the invention. A further object of the invention is the use of a surfactant as an additive to fire fighting foams and/or fire fighting foam concentrates, the surfactant comprising an acid group as well as an oligosilane unit and/or oligosiloxane unit. An example is the following:

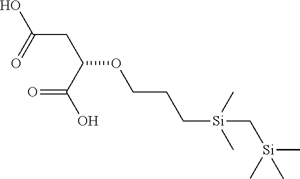 [SMILES: C[Si](C)(C)C[Si](C)(C)CCCO[C@@H](CC(=O)O)C(=O)O]

The present invention relates to a fire fighting foam concentrate comprising a first surfactant. It also relates to a method for extinguishing fires using this concentrate and the use of a surfactant as an additive to fire fighting foams and/or fire fighting foam concentrates.

Fires of large amounts of liquid (fuels, chemicals, organic solvents) are hardly or not controllable with conventional extinguishing agents. For this reason one uses special foams, so-called AFFF extinguishing foams (Aqueous Film Forming Foams, AFFF or A3F) for liquid fires or in difficult, complex or dangerous situations, such as in fuel depots, industrial plants, airports or in ship engine rooms.

The functional principle of such AFFF extinguishing foams beyond the “normal” extinguishing effect of a foam is based on the eponymous formation of a water film on the surface of the burning liquid.

The water film characteristic of AFFF extinguishing foams cools the surface, acts as a vapor barrier and allows fast sliding and spreading of the foam on the surface of the burning material. These properties make AFFF extinguishing foams tactically so valuable:
As a vapor barrier they prevent that the combustible liquid transits further into the gaseous phase and thus maintains the fire.
Due to the simple and rapid autonomous sliding of the foam on the surface of the burning liquid the foam spreads readily such that also locations can be reached, onto which the fire fighting foam cannot be applied directly. This is particularly of importance in the case of extended fires or fires in complex structures such as ship engine rooms, in which not each location can be reached directly by the foam tube.
Due to the rapid expansion of the foam, the extinguishing time and thus the risk for rescue forces and endangered people as well as the material damage caused by the fire are reduced.
Due to the formation of a water film of AFFF foams the foam cover closes by itself if it is injured such as by objects falling down (so-called self-healing) which in turn is advantageous for the operation success and safety of the rescue forces.

In order to achieve the water film formation effect characteristic for AFFF foam agents on apolar organic liquids (fuels, chemicals, organic solvents) specific surfactants are necessary which in certain physical parameters are superior to “normal” surfactants.

The formation of a water film on organic liquids, the so-called spreading, proceeds not voluntarily with water alone or with conventional surfactant solutions (e.g. conventional fire fighting foams).

A measure for the principle spreadability is the spreading coefficient S:

S=σ_{LO}−(σ_{LW}+σ_{WO})

σ_{LO}: Surface tension of the organic phase

σ_{LW}: Surface tension of the water/surfactant mixture

σ_{WO}: Interfacial tension between water/surfactant mixture and organic phase

In order to achieve a voluntary spreading, S must be positive. It follows that the surface tension of the water/surfactant mixture has to be reduced to the extent that the sum of it and the interfacial tension between the liquids is below the surface tension of the liquid to be wetted. The parameters σ_{LO} and σ_{WO} may be modified by the addition of surfactants to the water.

Until today, as a film former in commercially available AFFF extinguishing foams exclusively polyfluorinated surfactants (PFT) are used, which are very critical in terms of their ecological impact (persistence and accumulativity in the biosphere, climate impact in the atmosphere) and their toxic potential.

Perfluorooctyl sulfonate (PFOS) which was dominating as an AFFF extinguishing agent surfactant for a long time has been recognized in studies as toxic, persistent and bioaccumulative, i.e. as massively environmentally damaging and, thus, its use has been drastically restricted by a directive of the European Union (EU) and the Chemicals Prohibition Ordinance. Since 27 Jun. 2011 the use of fire extinguishing agents that contain more than 0.005% PFOS is prohibited within the EU.

Producers have responded to this restraint in that instead of perfluorooctyl derivatives now either somewhat shorter-chain perfluorinated surfactants (e.g. perfluorohexyl derivatives) or poly-fluorinated alternatives (so-called fluorotelomer tensides) are used in AFFF, which (so far) are not regulated by the above mentioned EU directive.

However, this fallback solution is not sustainable in any way, since on the one hand the environmental problem is not solved (even fluorotelomer tensides can be converted in nature to persistent, bioaccumulative and toxic perfluorinated or polyfluorinated degradation products) and since on the other hand it has to be expected that the legislature will issue new regulations in the medium-term in order to regulate this substance class(es), too.

Recently, compositions have been developed which avoid the drawbacks of the fluorine-containing surfactants. As an example, WO 2013/034521 A1 relates to a fire fighting foam concentrate which includes a surfactant containing at least one substituted or unsubstituted carbohydrate or carbohydrate derivative and at least one oligosiloxane. International Patent Application PCT/EP2014/054287 discloses a fire fighting foam concentrate which includes a surfactant containing at least one substituted or unsubstituted carbohydrate or carbohydrate derivative and at least one oligosilane.

Furthermore, EP 367381 A2 discloses surface-active silicone compounds with an increased stability at a pH value of over 9 or below 4 with the general formula:

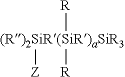

wherein each residue R is independently an alkyl or aryl group, each residue R′ is an alkylene group, which preferably separates adjacent silicon atoms by up to 3 carbon atoms from each other, each residue R″ is independently R or only when a=0, the group R₃SiR′—, Z denotes a substituent containing hydrophilic sulphur, nitrogen, or phosphorus or a carboxy functional group or a salt thereof and a has a value of 0, 1 or 2. Spreading properties, film forming properties, foaming properties or technical applications in particular in the field of fire fighting foam concentrates are not stated.

There is still a need for fire fighting foam concentrates with better water soluble and hydrolysis-stable environmentally compatible surfactant additives. It is an object of the present invention to provide such concentrates.

Said object is achieved according to the invention by a fire fighting foam concentrate comprising a first surfactant, wherein the first surfactant comprises an acid group and/or a deprotonated acid group and an oligosilane unit and/or oligosiloxane unit.

The concentrate according to the invention comprising the first surfactant has at least one of the following advantages:

Due to the high water solubility of the residues carrying (optionally deprotonated) acid groups the total molecular size of the first surfactants used according to the invention is sufficiently small with adequate solubility; small molecules are preferred for most applications because of their larger diffusion coefficients.

The first surfactant is halogen, in particular fluorine-free and can be produced mostly from renewable raw materials.

The first surfactants enable the autonomous formation of a closed water film on the surface of burning material (e.g. fuel): as a vapor barrier this water film inhibits the transition of the flammable liquid into the gas phase and minimizes in this way that the burning material maintains the fire or forms flammable/explosive gas mixtures.

The first surfactants have an excellent durability in particular hydrolytic stability. Furthermore, they are able to lower the surface tension of the water considerably.

The first surfactants are preferably not derived from sugar acids. Thus, the first surfactant may be described in more detail in that the first surfactant comprises an acid group and/or a deprotonated acid group and an oligosilane and/or oligosiloxane unit, wherein the acid group and/or deprotonated acid group is not part of a sugar acid radical. The sugar acids include aldonic acids, uronic acids and aldaric acids. Alternatively, the fact that the first surfactant is not derived from sugar acids, can also be described in that the first surfactant comprises an acid group and/or a deprotonated acid group and an oligosilane and/or oligosiloxane unit, wherein the first surfactant further comprises at most two, preferably at most one, and particularly preferably no hydroxyl group bound to a carbon atom which is not part of a carboxyl group.

The term “fire fighting foam concentrate” in the context of the present invention means a preparation which is added to the fire extinguishing water in order to obtain a fire fighting foam, extinguishing water added with surfactants or mixtures thereof. The water content of the fire fighting foam concentrate should be as low as possible, however, for practical reasons water can be added in order to reduce the viscosity of the concentrate.

Typical proportioning rates of fire fighting foam concentrate to water are 1 wt.-%, 3 wt.-%, or 6 wt.-%. Smaller proportioning rates (e.g. 0.5 wt.-%) for “super concentrates” are also conceivable.

Selected compounds falling under the general description of the first surfactant even comprise spreading characteristics.

Hereinafter, embodiments and other aspects of the present invention are described. They can be combined with each other, provided that from the context the contrary is not clearly evident.

In one embodiment of the fire fighting foam concentrate according to the invention the acid group is a carboxyl group and/or a sulfonic acid group.

In a further embodiment of the fire fighting foam concentrate according to the invention it further comprises an alkylpolyglycoside. Preferred are caprylic/decylglycosides such as are commercially available under the name Glucopon. The mass ratios of alkylpolyglycoside to the first surfactant (or a mixture of compounds which can be designated as the first surfactant), for example, may be in a range of ≧1:5 to ≦5:1.

In a further embodiment of the fire fighting foam concentrate according to the invention it comprises one or more additives which are selected from the group: foaming agents, film formers, film stabilizers, gelling agents, antifreeze agents, preservatives, corrosion inhibitors, solubilizers, buffers.

In the following these components are explained in more detail, wherein individual characteristics or details may be combined.

Foaming Agents:

For improving the foaming co-surfactants may be added. These in particular may be: linear alkylbenzenesulfonates, secondary alkanesulfonates, sodium alkylsulfonates, α-olefinsulfonates, sulfosuccinic acid esters, α-methyl ester sulfonates, alcohol ethoxylates, alkyl phenol ethoxylates, fatty alcohol ethylene oxide/propylene oxide adducts, glycoside surfactants (these are particularly preferred, e.g. Glucopon), lauryl sulfates , laureth sulfates, imidazolium salts, lauriminodipropionate, acrylic copolymers.

As suitable counterions for the anionic surfactants included in this list mainly Li⁺, Na⁺, K⁺, NH₄^{+,} N(C₂H₅)₄⁺ come into consideration.

Film Formers, Film Stabilizers:

For improving the film and foam properties, among others, the following components can be added to the foaming agent concentrate: polysaccharides, alginates, xanthan gum, starch derivatives.

Gelling Agents:

For improving the alcohol resistance, among others, the following components can be added to the foaming agent concentrate: polymers, polysorbates, fatty acid esters, carbon hydrate amphiphiles.

Antifreeze Agents:

For improving the frost resistance and the application ability at low temperatures, among others, the following components may be added to the foaming agent concentrate: ethylene glycol, propylene glycol, glycerol, 1-propanol, 2-propanol, urea, inorganic salts.

Preservatives and Anti-Corrosion Agents:

For improving the storage stability and protecting the storage vessels and apparatuses, among others, the following components may be added to the foaming agent concentrate: formaldehyde solution, aliphatic and/or aromatic aldehydes, alkylcarboxylic acid salts, ascorbic acid, salicylic acid, tolyltriazoles.

Solubilizers:

For improving the solubility of the components, among others, the following components may be added to the foaming agent concentrate: butyl glycol, butyl diglycol, hexylene glycol.

Buffers:

Buffering the concentrate at a slightly basic pH value is advantageous. Buffer systems may be, for example, potassium dihydrogen orthophosphate/sodium hydroxide, tris(hydroxymethyl)aminomethane/hydrochloric acid, disodium hydrogen phosphate/hydrochloric acid, disodium tetraborate/boric acid, sodium citrate/hydrochloric acid.

In a further embodiment of the fire fighting foam concentrate according to the invention the first surfactant is present in an amount of ≧0.5 wt.-% to ≦100 wt.-% based on the total weight of the concentrate. The proportion is preferably ≧1 wt.-% to ≦90 wt.-%, more preferably ≧1.5 wt.-% to ≦80 wt.-%.

In a further embodiment of the fire fighting foam concentrate according to the invention the water content is ≧0 wt.-%> to ≦80 wt.-% based on the total weight of the concentrate. The proportion is preferably ≧0 wt.-% to ≦50 wt.-%, more preferably ≧0 wt.-% to ≦20 wt.-%>.

In a further embodiment of the fire fighting foam concentrate according to the invention the first surfactant is described by one of the following formulas:

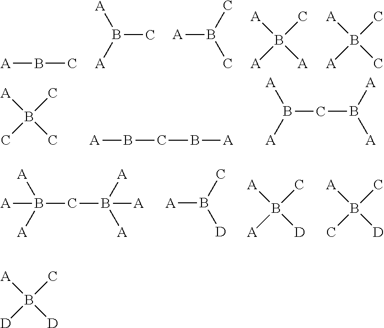

wherein:
A is an unsubstituted or substituted residue which carries an acid group or a deprotonated acid group;
B is an optional linker structure consisting of at least one atom or a chain;
C is an oligosilane residue or an oligosiloxane residue; and
D is an oligosiloxane residue.

Hereinafter the sub-components A to D are described in detail, wherein individual features or details can be arbitrarily combined.

Sub-Component A:

Sub-component A according to the invention is an unsubstituted or substituted residue which carries an acid group or a deprotonated acid group. Preferably, the acid groups are carboxyl groups and/or sulfonic acid groups.

Sub-Component B:

B is an optional linker sub-structure consisting of at least one atom or a chain, preferably of carbon and/or nitrogen and/or oxygen atoms (wherein O—O bonds should be excluded).

This chain may be a pure alkyl chain, i.e., B is an unsubstituted or optionally alkyl-substituted alkylene residue, preferably comprising three, four, five, six or seven carbon atoms. Particularly preferred are propylene bridges (i.e. three carbon atoms).

Alternatively, B may comprise ether, ester, amide or amine groups. For example, B may include glycerol, pentaerythritol, carbohydrates, alkylamines or carboxylic acids as a substructure.

Still alternatively, and as such preferably B includes an oligoethylene oligopropylene glycol unit, preferably comprising two, three or four units. Preferably an ethylene or propylene unit serves as a bond to the residue C.

B is bond to the residue B via an Si—C, Si—O or Si—N bond.

It should be noted that in some first surfactants according to the present invention sub-component B may be omitted, i.e., A and C are optionally directly linked to each other.

Sub-Component C:

C is an oligosilane, preferably a di, tri, tetra or pentasilane, wherein C is not explicitly restricted thereto and also larger residues should be encompassed. “Oligosilane” in the context of the present invention means compounds or residues/“partial compounds”, which either
include more than one SiR¹R²R³R⁴ unit (wherein R¹, R², R³, R⁴=identical or different organic residues, such that four Si—C bonds are present); or
include a SiR¹R²R³R⁴ unit (wherein R¹, R², R³, R⁴=identical or different organic residues, such that four Si—C bonds are present) and at least one further siloxane unit (i.e., a compound SiR¹R²R³R⁴, wherein at least one of the components R is an alkoxy or oxo residue). It should be noted that these compounds are usually referred to as oxacarbosilanes. In the context of this invention, however, for the sake of readability and clarity these compounds for simplicity are also referred to as oligosilanes or these compounds are also classified under the group of oligosilanes.

Herein, the terminal silanes tri(m)ethylsilane (i.e. they have three methyl and/or ethyl units or two methyl and one ethyl or two ethyl and one methylene unit(s)) are preferred.

Herein, the individual silanes are preferably linked via methylene, ethylene or propylene bridges, particularly preferably methylene units, since they do not excessively reduce the amphiphobicity of the entire molecule. In the event that C also includes siloxane units, of course Si—O—Si bridges are present.

If C is a tri- or higher silane, C may be linked with B (or optionally A) via one of the terminal silanes (such that a continuous chain is formed), alternatively C may be linked with B (or optionally A) via one of the mid-chain silanes such that a kind of X- or T-shaped or branched structure is obtained.

If necessary, the sub-structures A-B or A linked with C may be of the same kind or different.

Preferably C is described by one of the following formulas:

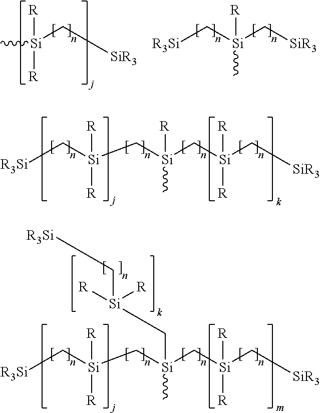

wherein each R is independently ethyl or methyl, n (each independently) is 1, 2 or 3, and j, k, m are 1-9, wherein 1≦j+k+m≦10;

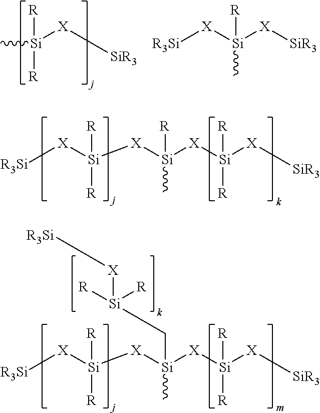

wherein each R is independently ethyl or methyl, each X is independently (CH₂)ₙ or O, wherein n (each independently) is 1, 2 or 3, and j, k, m are 1-9, wherein 1≦j+k+m≦10; as well as

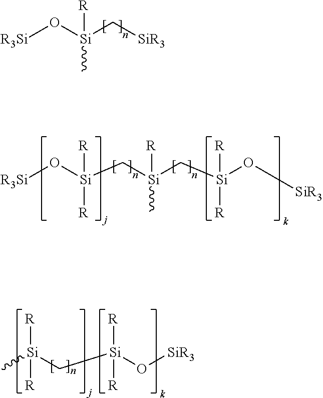

wherein each R is independently ethyl or methyl, each X is independently (CH₂)ₙ or O, n (each independently) is 1, 2 or 3, and j, k are 1-9, wherein 1≦j+k≦10.

If C is mid-chain, of course, one of the residues R is modified accordingly.

Sub-Component D:

D is an oligosiloxane, preferably a di-, tri- or tetrasiloxane. Herein, the methyl and ethyl siloxanes or mixed siloxanes with methyl and ethyl residues are preferred.

If C is a tri- or higher siloxane D may be linked with B (or optionally A) via one of the terminal siloxanes (such that a kind of “continuous chain” is formed), alternatively D may be linked with B (or optionally A) via one of the mid-chain siloxanes such that a kind of X- or T-shaped or branched structure is formed.

If D is derived from a di- or trihydrosiloxane the sub-structures A-B or A linked with D may be identical or different.

Preferably, D has one of the following structures:

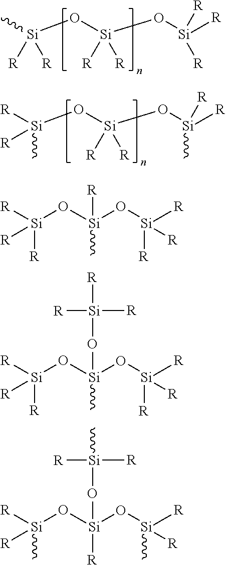

wherein each R is independently ethyl or methyl and n is between 0 and 10, preferably between 0 and 5 and more preferably is 0, 1 or 2.

In a further embodiment of the fire fighting foam concentrate according to the invention it comprises ≧0.05 mol-% to ≦100 mol-% of a base with respect to the amount of substance of carboxyl groups provided by the first surfactant. Preferred base proportions are ≧0.07 mol-% to ≦50 mol-%, more preferably ≧0.1 mol-% to ≦5 mol-%.

In a further embodiment of the fire fighting foam concentrate according to the invention the first surfactant is selected from the following group:

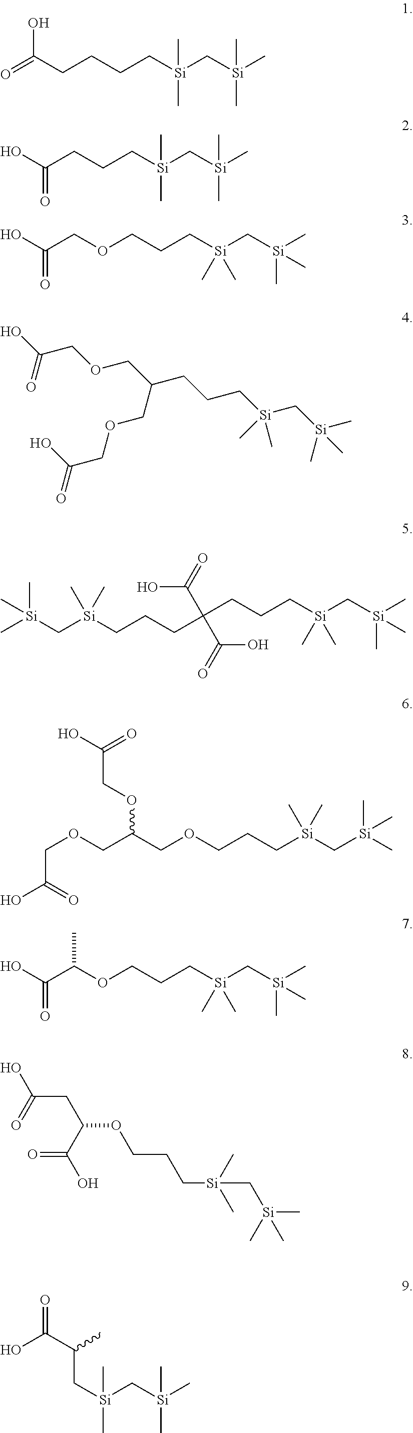

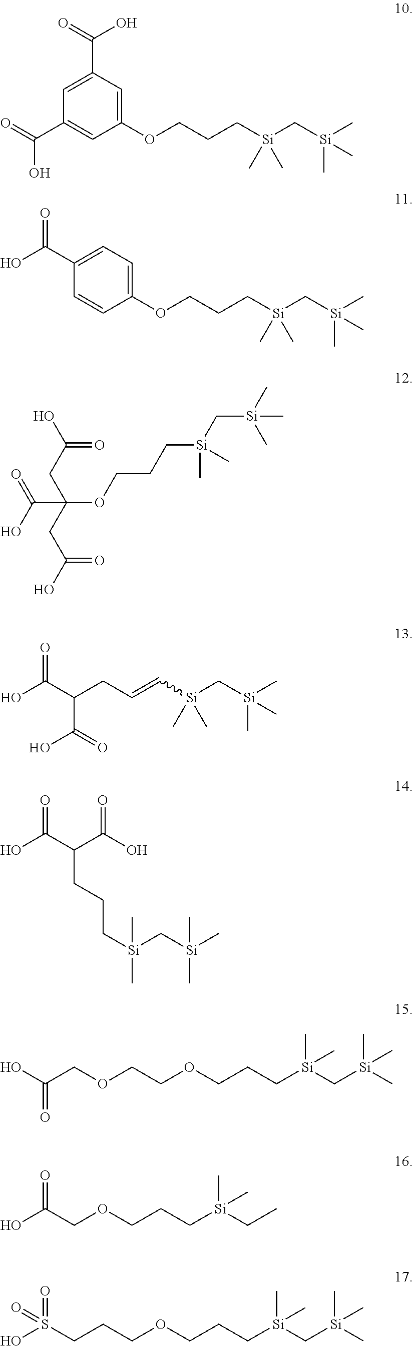

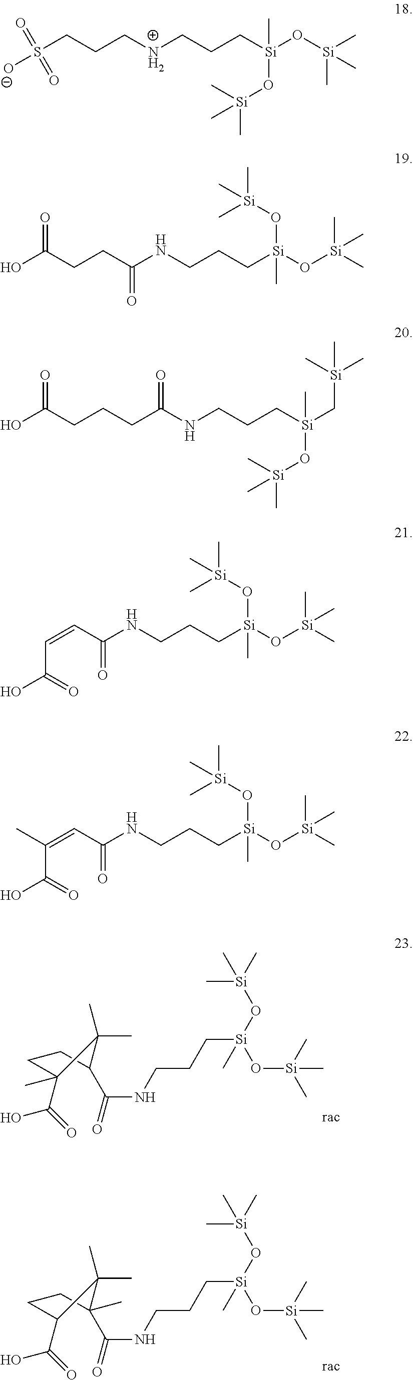

and/or salts of the aforementioned compounds. Preferably, the compounds Nos. 5, 6, 8, 9, 12, 13, 14, 15, 16, 17, 18, 19, 20, 21, 22 and 23 are optionally present in combination with an alkyl polyglycoside such as the above described Glucopon.

Another subject matter of the present invention is a method for extinguishing fires, comprising the steps of:
providing a firefighting foam concentrate;
adding the fire fighting foam concentrate to water in order to obtain a mixture;
contacting a fire site with the mixture;
   wherein the fire fighting foam concentrate is a fire fighting foam concentrate according to the present invention.

The resulting mixture can be foamed and applied in an appropriate manner directly or indirectly to the fire site. However, it is also possible to use the mixture unfoamed as so-called net water. This approach is particularly advantageous in the control of hot spots.

According to the invention, there is also provided the use of a surfactant as an additive to fire fighting foams and/or fire fighting foam concentrates, wherein the surfactant comprises an acid group and/or a deprotonated acid group and an oligosilane and/or oligosiloxane unit. Of course, the details described in connection with the fire fighting foam concentrate with respect to the first surfactant also apply to the use according to the invention. In order to avoid unnecessary repetitions, they are not specified separately here.

The components to be used according to the invention mentioned above and claimed and described in the exemplary embodiments are not subject to specific restrictions with respect to their size, design, material selection and technical conception such that the selection criteria well-known in the field of application can be applied without restriction.

Further details, features and advantages of the subject matter of the invention are obvious from the dependent claims and the following description of the associated examples which are purely illustrative and not restrictive.

Synthetic routes to the first surfactants according to the invention are given below. Exemplary references are:

K. Krohn, A. Vidal, J. Vtz, B. Westermann, M. Abbas, I. Green, Tetrahedron Asymmetry 2006, 17, 3051-3057; A. Venkanna, E. Sreedhar, B. Siva, K. S. Babu, K. R. Prasad, J. M. Rao, Tetrahedron-Asymmetry 2013, 24, 1010-1022; A. Dahlgren, P. O. Johansson, I. Kvarnstrom. D. Musil, I. Nilsson, B. Samuelsson, Bioorganic & Medicinal Chemistry 2002, 10, 1829-1839; R. Epple, M. Azimioara, R. Russo, X. P. Xie, X. Wang, C. Cow, J. Wityak, D. Karanewsky, B. Bursulaya, A. Kreusch, T. Tuntland, A. Gerken, M. Iskander, E. Saez, H. M. Seidel, S. S. Tian, Bioorganic & Medicinal Chemistry 2006, 16, 5488-5492; and WO 2007/014471 A1.

The Karstedt's catalyst mentioned in the system schemes is a catalyst in which the active species is present as platinum(0). Hexachloridoplatinic acid in isopropanol can serve as precatalyst (Speier catalyst). If this catalyst system is reacted with additives such as 1,1,3,3-tetramethyl-1,3-divinyldisiloxane one speaks of the Karstedt's catalyst.

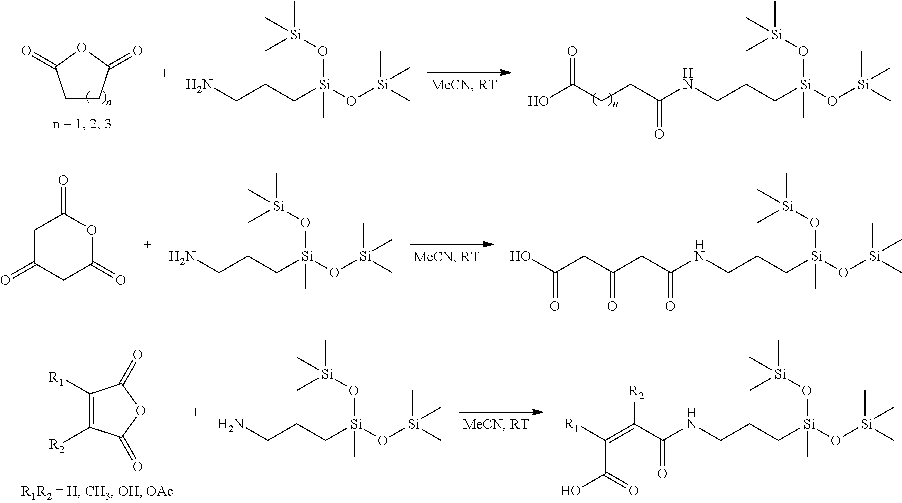

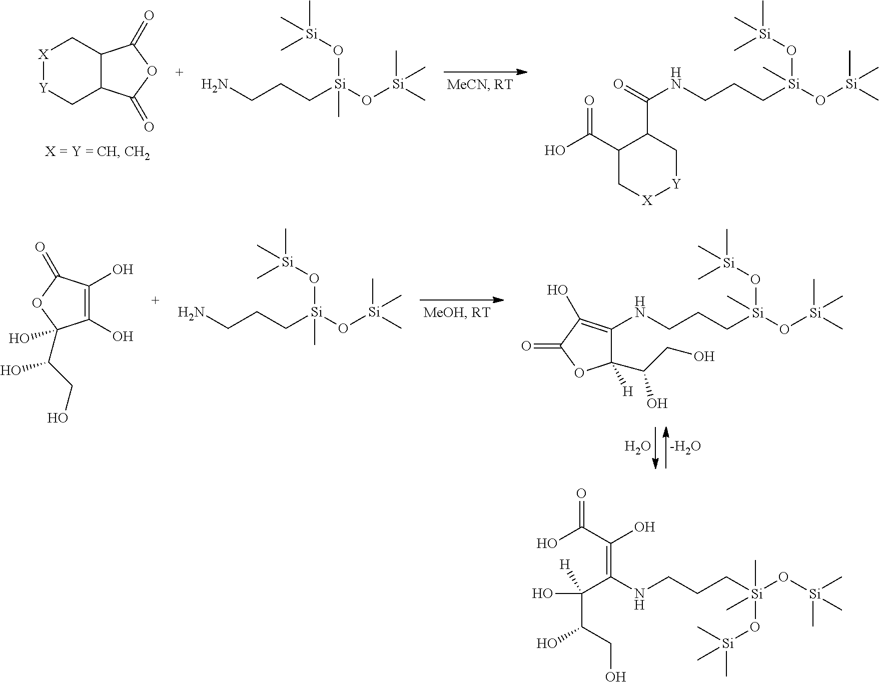

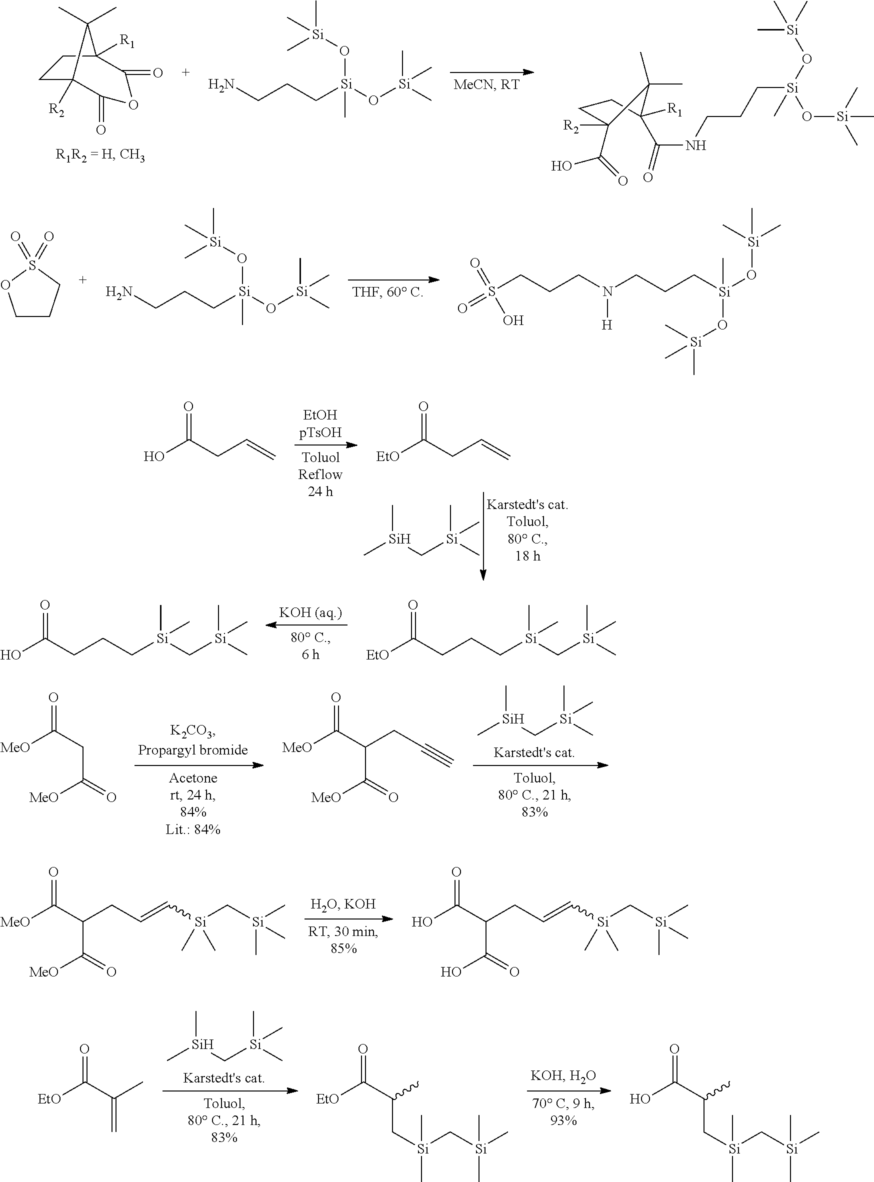

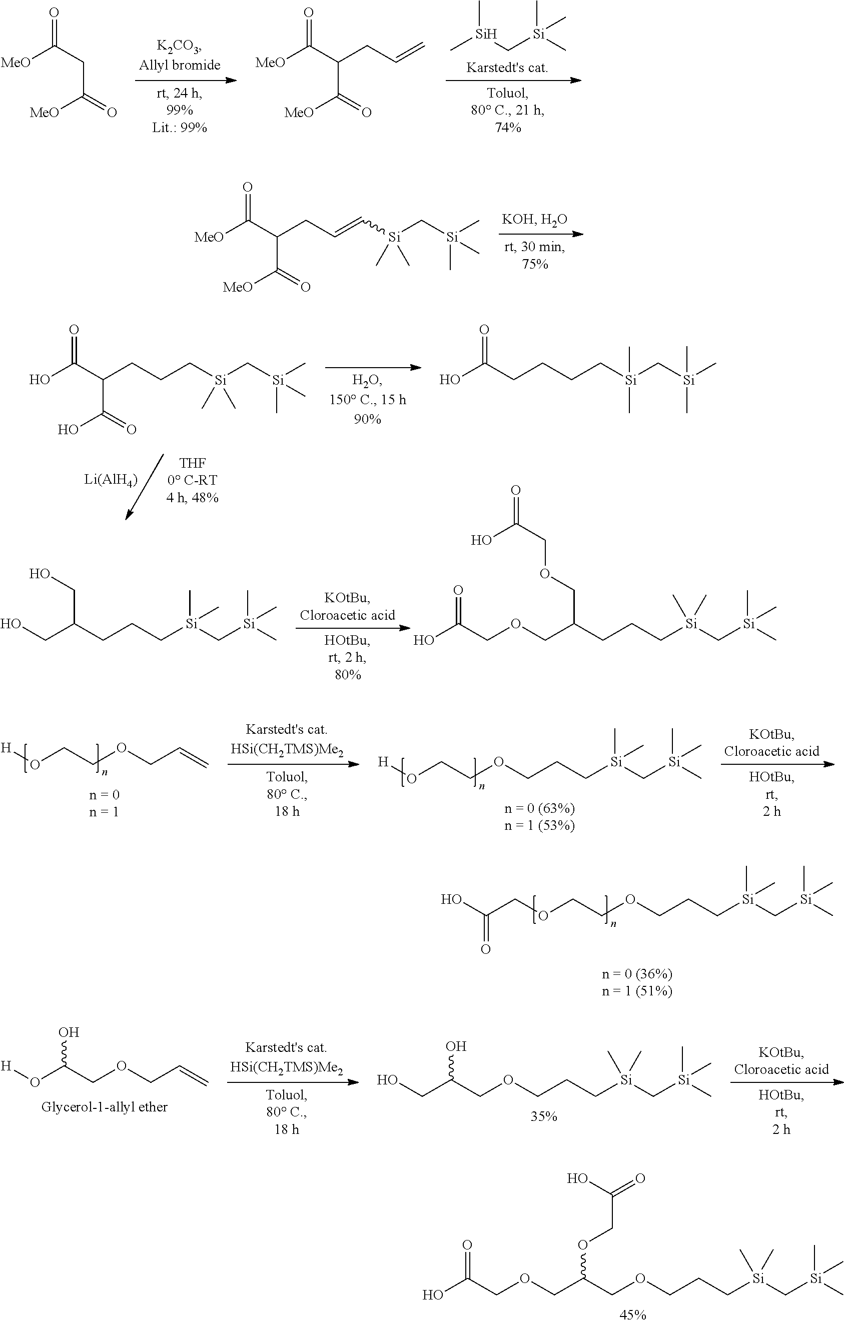

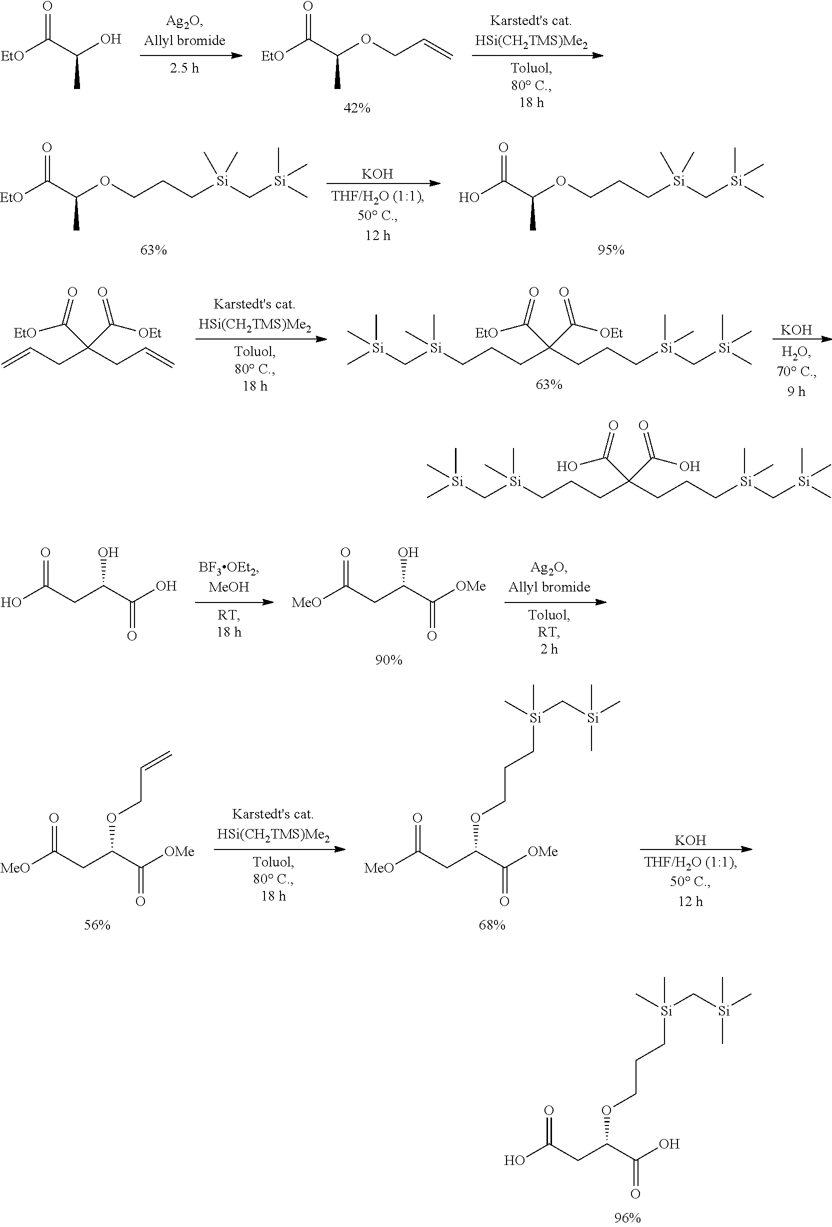

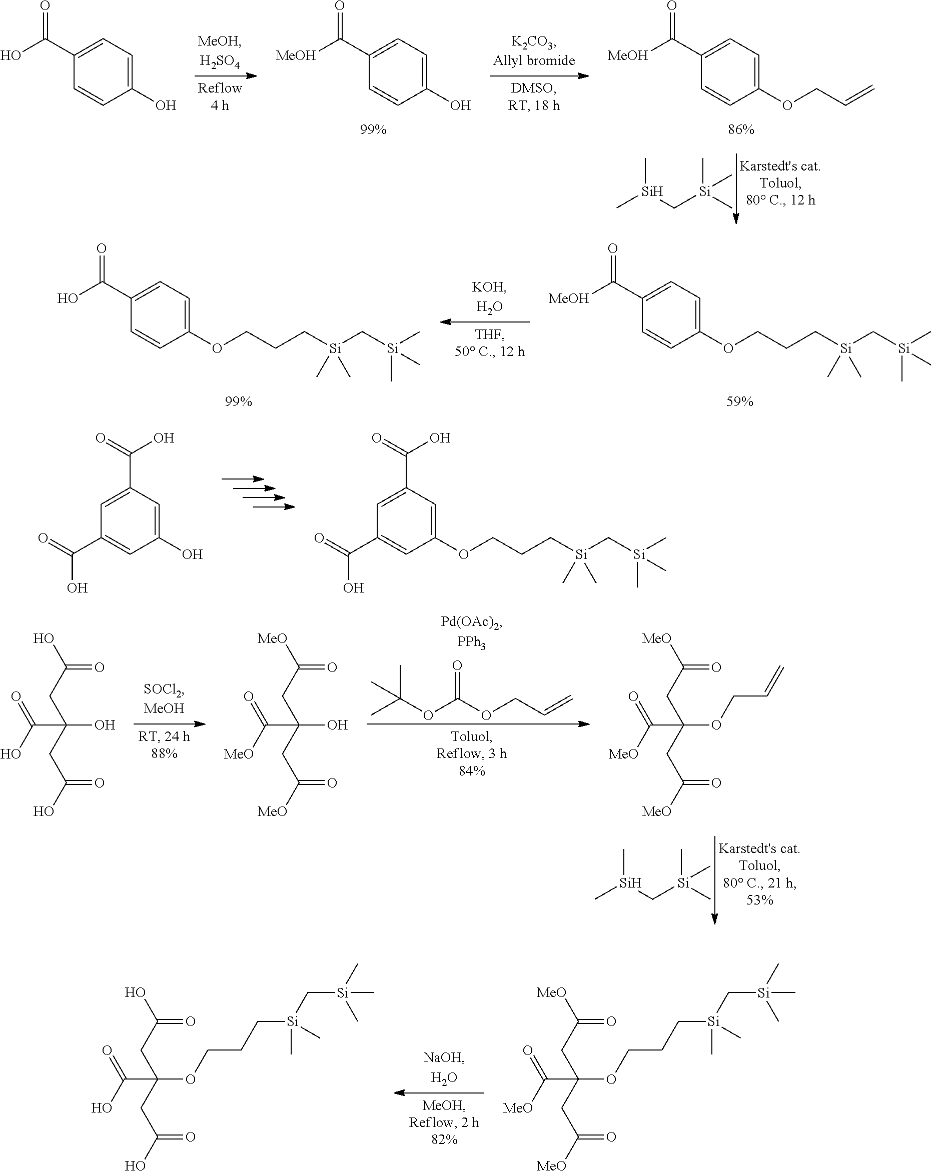

Investigation of the Spreading Behaviour

In order to investigate the spreading behaviour 5 ml cyclohexane were placed in a Petri dish of 9 cm diameter. Then one drop of the non-foamed surfactant solution was respectively put thereon, and it was observed whether and how the surfactant solution spreads on the surface of the cyclohexane.

The evaluation of the test results was implemented qualitatively in levels “does not spread”, “spreads very badly”, “spreads badly”, “spreads moderately”, “spreads well” and “spreads very well”.

The surfactant used were aqueous solutions of carboxylsilane surfactants optionally with additional Glucopon 215 UP (aqueous solution of caprylic/decylglycoside (alkylpolyglycoside), 63 to 65 wt.-% active substance content, BASF SE). Glucopon 215 UP has a pH value (10% in 15% isopropanol) from 11.5 to 12.5.

As a base NaOH was used.

All tested compounds were able to form a foam on contact with water. Furthermore, all of the compounds were able to reduce the surface tension of the water to very low values. Furthermore, they are stable over wide pH ranges.

Investigation of Surface and Interfacial Tension

The surface and interfacial tensions were measured by means of a Kruss K11 tensiometer equipped with a Wilhelmy platinum plate at 25° C. All solutions were prepared from a first surfactant, optionally a co-tenside (Glucopon), optionally base and ultrapure water (conductivity<0.055 μS/cm). When filling the surfactant solution into the measuring vessel of the tensiometer it has to be ensured that there is no foam on the surface.

For measuring the surface tension the mean value of 4 consolidated series of measurements was respectively calculated, and for measuring the interfacial tension a consolidated series of measurements has been detected. A consolidated series of measurement consists of at least 5 consecutively measured individual measurements with a standard deviation σ<0.05 mN/m (in practice, this means about 10 individual measurements per consolidated series of measurements).

In the examples, cmc denotes the critical micelle concentration; δ_{LW} the surface tension of the water/surfactant mixture; σ_{WO} the interfacial tension between water/surfactant mixture and organic phase; and S the spreading coefficient.

### EXAMPLE 1

Investigated Compound:

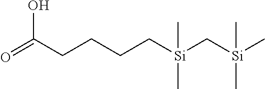

| Concentr. | Eq. of | Concentr. | |
|---|---|---|---|
| example [g/l] | base | Glucopon (g/l) | Spreading behaviour |
| 20 | 2 | 0 | Spreads badly |
| 10 | 2 | 0 | Does not spread |
| 20 | 1 | 0 | Spreads very badly |
| 10 | 1 | 0 | Does not spread |
| 20 | 0 | 0 | Does not spread |
| 20 | 0 | 6.7 | Spreads very badly |

In the following investigation 1 equivalent of base was added:

| cmc [mmol/l] | σ_{LW, min} [mN/m] | σ_{WO, min} [mN/m] | S [mN/m] |
|---|---|---|---|
| 20.6 | 22.4 | 2.4 | 0.1 |

### EXAMPLE 2

Investigated Compound:

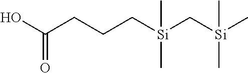

| Concentr. | Eq. of | Concentr. | |
|---|---|---|---|
| example [g/l] | base | Glucopon (g/l) | Spreading behaviour |
| 20 | 0 | 0 | Does not spread |
| 20 | 0 | 6.7 | Spreads very badly |

In the following investigation Glucopon was added:

| cmc [mmol/l] | σ_{LW, min} [mN/m] | σ_{WO, min} [mN/m] | S [mN/m] |
|---|---|---|---|
| 0.33 | 21.8 | 1.9 | 1.2 |

### EXAMPLE 3

Investigated Compound:

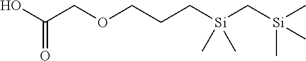 [SMILES: C[Si](C)(C)C[Si](C)(C)CCCOCC(=O)O]

| Concentr. | | Concentr. | Spreading |
|---|---|---|---|
| example [g/l] | Eq. of base | Glucopon (g/l) | behaviour |
| 10 | 1 | 0 | Spreads badly |
| 2.0 | 1 | 0 | Does not spread |
| 1.3 | 1 | 0 | Does not spread |

### EXAMPLE 4

Investigated Compound:

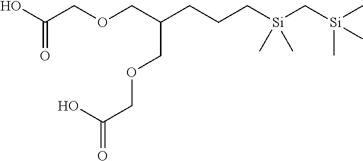 [SMILES: C[Si](C)(C)C[Si](C)(C)CCCC(COCC(=O)O)COCC(=O)O]

| Concentr. | | Concentr. | Spreading |
|---|---|---|---|
| example [g/l] | Eq. of base | Glucopon (g/l) | behaviour |
| 2.0 | 0 | 0 | Does not spread |
| 1.3 | 0 | 0 | Does not spread |
| 4.0 | 0 | 6.7 | Spreads badly |

| cmc [mmol/l] | σ_{LW,min} [mN/m] | σ_{WO,min} [mN/m] | S [mN/m] |
|---|---|---|---|
| 0.25 | 22.7 | 1.1 | 1.1 |

### EXAMPLE 5

Investigated Compound:

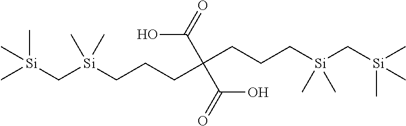

| Concentr. | | Concentr. | Spreading |
|---|---|---|---|
| example [g/l] | Eq. of base | Glucopon (g/l) | behaviour |
| 2.0 | 2 | 0 | Does not spread |
| 1.3 | 2 | 0 | Does not spread |
| 2.0 | 0 | 6.7 | Spreads well |
| 1.3 | 0 | 6.7 | Spreads well |
| 0.9 | 0 | 6.7 | Spreads moderately |
| 0.6 | 0 | 6.7 | Spreads badly |
| 0.4 | 0 | 6.7 | Does not spread |

In the following investigation 2 equivalents of base were added:

| cmc [mmol/l] | σ_{LW,min} [mN/m] | σ_{WO,min} [mN/m] | S [mN/m] |
|---|---|---|---|
| 1.53 | 21.3 | 0.1 | 3.5 |

### EXAMPLE 6

Investigated Compound:

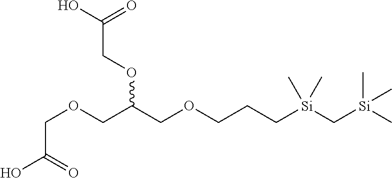 [SMILES: C[Si](C)(C)C[Si](C)(C)CCCOCC(COCC(=O)O)OCC(=O)O]

| Concentr. | | Concentr. | Spreading |
|---|---|---|---|
| example [g/l] | Eq. of base | Glucopon (g/l) | behaviour |
| 2.0 | 2 | 0 | Does not spread |
| 1.3 | 2 | 0 | Does not spread |
| 4.0 | 0 | 6.7 | Spreads very well |
| 2.0 | 0 | 6.7 | Spreads well |
| 1.3 | 0 | 6.7 | Spreads hardly |
| 0.9 | 0 | 6.7 | Does not spread |
| 0.6 | 0 | 6.7 | Does not spread |

| cmc [mmol/l] | σ_{LW,min} [mN/m] | σ_{WO,min} [mN/m] | S [mN/m] |
|---|---|---|---|
| 0.26 | 22.5 | 0.4 | 2.0 |

### EXAMPLE 7

Investigated Compound:

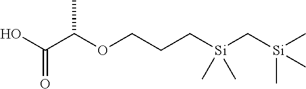 [SMILES: C[C@H](OCCC[Si](C)(C)C[Si](C)(C)C)C(=O)O]

| Concentr. | | Concentr. | Spreading |
|---|---|---|---|
| example [g/l] | Eq. of base | Glucopon (g/l) | behaviour |
| 2.0 | 1 | 0 | Does not spread |
| 1.3 | 1 | 0 | Does not spread |
| 16.0 | 0 | 6.7 | Spreads badly |
| 2.0 | 0 | 6.7 | Does not spread |
| 1.3 | 0 | 6.7 | Does not spread |
| 0.9 | 0 | 6.7 | Does not spread |
| 0.6 | 0 | 6.7 | Does not spread |

In the following investigation Glucopon was added:

| cmc [mmol/l] | σ_{LW,min} [mN/m] | σ_{WO,min} [mN/m] | S [mN/m] |
|---|---|---|---|
| 2.28 | 22.2 | 1.2 | 1.5 |

### EXAMPLE 8

Investigated Compound:

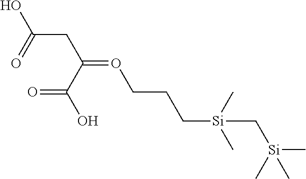

| Concentr. | | Concentr. | Spreading |
|---|---|---|---|
| example [g/l] | Eq. of base | Glucopon (g/l) | behaviour |
| 2.0 | 0 | 0 | Does not spread |
| 1.3 | 0 | 0 | Does not spread |
| 0.9 | 0 | 0 | Does not spread |
| 2.0 | 0 | 6.7 | Spreads very well |
| 1.3 | 0 | 6.7 | Spreads very well |
| 0.9 | 0 | 6.7 | Spreads well |
| 0.6 | 0 | 6.7 | Does not spread |

| cmc [mmol/l] | σ_{LW,min} [mN/m] | σ_{WO,min} [mN/m] | S [mN/m] |
|---|---|---|---|
| 0.47 | 21.4 | 0.5 | 3.0 |

### EXAMPLE 9

Investigated Compound:

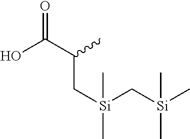

| Concentr. | | Concentr. | Spreading |
|---|---|---|---|
| example [g/l] | Eq. of base | Glucopon (g/l) | behaviour |
| 2.0 | 0 | 0 | Spreads well |
| 1.3 | 0 | 0 | Spreads well |
| 0.9 | 0 | 0 | Spreads moderately |
| 0.6 | 0 | 0 | Spreads badly |
| 0.4 | 0 | 0 | Does not spread |
| 2.0 | 0 | 6.7 | Spreads well |
| 1.3 | 0 | 6.7 | Spreads well |
| 0.9 | 0 | 6.7 | Spreads moderately |
| 0.6 | 0 | 6.7 | Spreads badly |
| 0.4 | 0 | 6.7 | Does not spread |

In the following investigation Glucopon was added:

| cmc [mmol/l] | σ_{LW,min} [mN/m] | σ_{WO,min} [mN/m] | S [mN/m] |
|---|---|---|---|
| 2.11 | 22.3 | 1.0 | 1.6 |

### EXAMPLE 10

Investigated Compound:

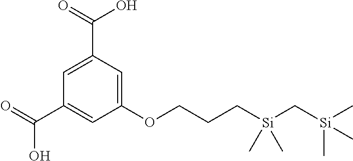 [SMILES: C[Si](C)(C)C[Si](C)(C)CCCOc1cc(C(=O)O)cc(C(=O)O)c1]

| Concentr. | | Concentr. | Spreading |
|---|---|---|---|
| example [g/l] | Eq. of base | Glucopon (g/l) | behaviour |
| 2.0 | 0 | 0 | Does not spread |
| 2.0 | 0 | 6.7 | Does not spread |

### EXAMPLE 11

Investigated Compound:

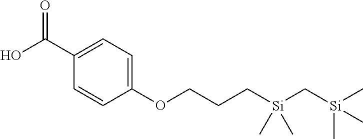 [SMILES: C[Si](C)(C)C[Si](C)(C)CCCOc1ccc(C(=O)O)cc1]

| Concentr. | | Concentr. | Spreading |
|---|---|---|---|
| example [g/l] | Eq. of base | Glucopon (g/l) | behaviour |
| 2.0 | 0 | 0 | Does not spread |
| 2.0 | 0 | 6.7 | Does not spread |

### EXAMPLE 12

Investigated Compound:

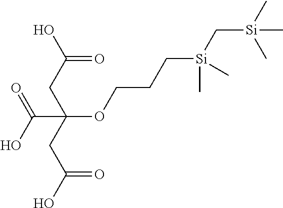 [SMILES: C[Si](C)(C)C[Si](C)(C)CCCOC(CC(=O)O)(CC(=O)O)C(=O)O]

| Concentr. | | | Spreading |
|---|---|---|---|
| example [g/l] | Eq. of base | Concentr. Glucopon (g/l) | behaviour |
| 2.0 | 0 | 0 | Spreads well |
| 2.0 | 0 | 6.7 | Spreads very well |

### EXAMPLE 13

Investigated Compound:

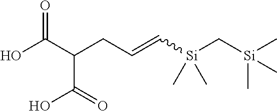 [SMILES: C[Si](C)(C)C[Si](C)(C)C=CCC(C(=O)O)C(=O)O]

| Concentr. | | | Spreading |
|---|---|---|---|
| example [g/l] | Eq. of base | Concentr. Glucopon (g/l) | behaviour |
| 2.0 | 0 | 0 | Does not spread |
| 2.0 | 0 | 6.7 | Spreads very well |

### EXAMPLE 14

Investigated Compound:

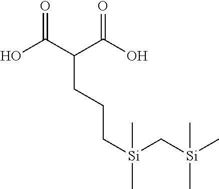 [SMILES: C[Si](C)(C)C[Si](C)(C)CCCC(C(=O)O)C(=O)O]

| Concentr. | | Concentr. Glucopon | |
|---|---|---|---|
| example [g/l] | Eq. of base | (g/l) | Spreading behaviour |
| 6.0 | 1 | 0 | Spreads well |
| 3.6 | 1 | 0 | Spreads well |
| 2.2 | 1 | 0 | Spreads moderately |
| 1.3 | 1 | 0 | Spreads badly |
| 0.8 | 1 | 0 | Spreads badly |
| 0.5 | 1 | 0 | Does not spread |
| 1.5 | 0 | 6.7 | Spreads very well |
| 1.1 | 0 | 6.7 | Spreads very well |
| 0.8 | 0 | 6.7 | Spreads well |
| 0.6 | 0 | 6.7 | Spreads moderately |
| 0.5 | 0 | 6.7 | Does not spread |

| cmc [mmol/l] | σ_{LW,min} [mN/m] | σ_{WO,min} [mN/m] | S [mN/m] |
|---|---|---|---|
| 0.20 | 21.4 | 0.7 | 2.8 |

### EXAMPLE 15

Investigated Compound:

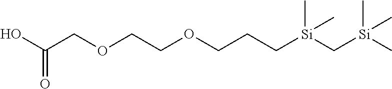 [SMILES: C[Si](C)(C)C[Si](C)(C)CCCOCCOCC(=O)O]

| Concentr. | Eq. | | |
|---|---|---|---|
| example [g/l] | of base | Concentr. Glucopon (g/l) | Spreading behaviour |
| 2.0 | 0 | 0 | Does not spread |
| 2.0 | 0 | 6.7 | Spreads moderately |

### EXAMPLE 16

Investigated Compound:

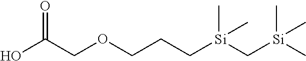 [SMILES: C[Si](C)(C)C[Si](C)(C)CCCOCC(=O)O]

| Concentr. | Eq. | | |
|---|---|---|---|
| example [g/l] | of base | Concentr. Glucopon (g/l) | Spreading behaviour |
| 2.0 | 0 | 0 | Does not spread |
| 2.0 | 0 | 6.7 | Spreads moderately |

| cmc [mmol/l] | σ_{LW,min} [mN/m] | σ_{WO,min} [mN/m] | S [mN/m] |
|---|---|---|---|
| 42.2 | 23.1 | 1.5 | 0.3 |

### EXAMPLE 17

Investigated Compound:

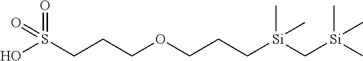 [SMILES: C[Si](C)(C)C[Si](C)(C)CCCOCCCS(=O)(=O)O]

| Concentr. | | | Spreading |
|---|---|---|---|
| example [g/l] | Eq. of base | Concentr. Glucopon (g/l) | behaviour |
| 2.0 | 1.0 | 0 | Does not spread |
| 2.0 | 1.0 | 6.7 | Spreads badly |

### EXAMPLE 18

Investigated Compound:

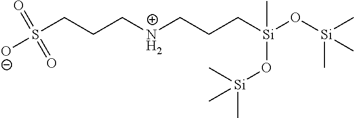 [SMILES: C[Si](C)(C)O[Si](C)(CCC[NH2+]CCCS(=O)(=O)[O-])O[Si](C)(C)C]

| Concentr. | | | Spreading |
|---|---|---|---|
| example [g/l] | Eq. of base | Concentr. Glucopon (g/l) | behaviour |
| 4.0 | 1.0 | 0 | Spreads well |
| 4.0 | 1.0 | 6.7 | Spreads very well |

| Concentr. | | Concentr. | σ_{LW,min} | |
|---|---|---|---|---|
| example [g/l] | Eq. of base | Glucopon (g/l) | [mN/m] | σ_{WO,min} [mN/m] |
| 5.0 | 1 | 0 | 19.3 | 0.7 |
| 5.0 | 1 | 6.7 | 20.2 | 0.6 |

### EXAMPLE 19

Investigated Compound:

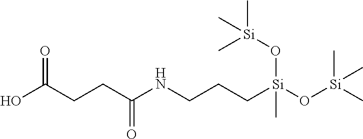 [SMILES: C[Si](C)(C)O[Si](C)(CCCNC(=O)CCC(=O)O)O[Si](C)(C)C]

| Concentr. | | Concentr. | σ_{LW,min} | |
|---|---|---|---|---|
| example [g/l] | Eq. of base | Glucopon (g/l) | [mN/m] | σ_{WO,min} [mN/m] |
| 5 | 1 | 0 | 23.8 | 7.3 |
| 2.5 | 0 | 6.7 | 20.7 | 0.3 |

### EXAMPLE 20

Investigated Compound:

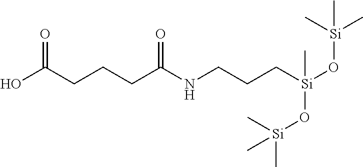 [SMILES: C[Si](C)(C)O[Si](C)(CCCNC(=O)CCCC(=O)O)O[Si](C)(C)C]

| Concentr. | | Concentr. | σ_{LW,min} | |
|---|---|---|---|---|
| example [g/l] | Eq. of base | Glucopon (g/l) | [mN/m] | σ_{WO,min} [mN/m] |
| 5 | 1 | 0 | 19.1 | 5.27 |
| 5 | 0 | 6.7 | 19.7 | 0.77 |
| 5 | 1 | 6.7 | 21.7 | — |

### EXAMPLE 21

Investigated Compound:

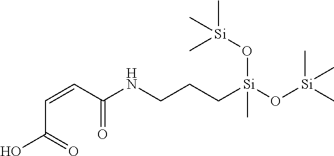 [SMILES: C[Si](C)(C)O[Si](C)(CCCNC(=O)/C=C\C(=O)O)O[Si](C)(C)C]

| Concentr. | | Concentr. | σ_{LW,min} | |
|---|---|---|---|---|
| example [g/l] | Eq. of base | Glucopon (g/l) | [mN/m] | σ_{WO,min} [mN/m] |
| 5 | 1 | 0 | 19.6 | 2.22 |
| 5 | 0 | 6.7 | 20.0 | 0.1 |

### EXAMPLE 22

Investigated Compound:

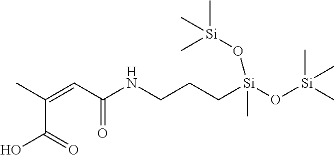 [SMILES: C/C(=C/C(=O)NCCC[Si](C)(O[Si](C)(C)C)O[Si](C)(C)C)C(=O)O]

| Concentr. | | Concentr. | σ_{LW,min} | |
|---|---|---|---|---|
| example [g/l] | Eq. of base | Glucopon (g/l) | [mN/m] | σ_{WO,min} [mN/m] |
| 5.0 | 1 | 0 | 22.9 | — |
| 5.0 | 1 | 6.7 | 21.2 | — |

### EXAMPLE 23

Investigated Compound:

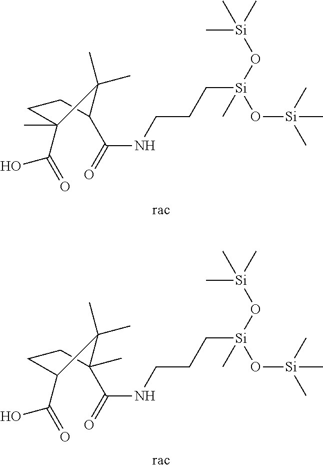 [SMILES: CC1(C(=O)O)CCC(C(=O)NCCC[Si](C)(O[Si](C)(C)C)O[Si](C)(C)C)C1(C)C ; CC1(C(=O)NCCC[Si](C)(O[Si](C)(C)C)O[Si](C)(C)C)CCC(C(=O)O)C1(C)C]

| Concentr. | | Concentr. | σ_{LW,min} | |
|---|---|---|---|---|
| example [g/l] | Eq. of base | Glucopon (g/l) | [mN/m] | σ_{WO,min} [mN/m] |
| 5.0 | 1 | 0 | 24.7 | — |
| 5.0 | 1 | 6.7 | — | — |

The individual combinations of the components and the features of the embodiments mentioned above are exemplary, the exchange and substitution of these teachings with other teachings included in this publication with the cited references are also expressly contemplated. A person skilled in the art will recognize that variations, modifications and other embodiments described herein may also occur without departing from the spirit and scope of the invention.

Accordingly, the above description is to be considered exemplary rather than limiting. The term “comprise” or “include” used in the claims does not exclude other elements or steps. The indefinite article “a” or “an” does not exclude the importance of a plural. The mere fact that certain measures are recited in mutually different claims, does not imply that a combination of these measures cannot be used to advantage. The scope of the invention is defined by the following claims and the associated equivalents.

1. A fire fighting foam concentrate comprising a first surfactant, wherein the first surfactant comprises an acid group and/or or a deprotonated acid group and an oligosilane unit and/or oligosiloxane unit.

2. The fire fighting foam concentrate according to claim 1, wherein the acid group is a carboxyl group and/or a sulfonic acid group.

3. The fire fighting foam concentrate according to claim 1, further comprising an alkylglycoside or alkylpolyglycoside.

4. The fire fighting foam concentrate according to claim 1, further comprising one or more additives which are selected from the group: foaming agents, film formers, film stabilizers, gelling agents, antifreeze agents, preservatives, corrosion inhibitors, solubilizers, buffers.

5. The fire fighting foam concentrate according to claim 1, wherein the first surfactant is present in an amount of ≧0.5 wt.-% to ≦100 wt.-% based on the total weight of the concentrate.

6. The fire fighting foam concentrate according to claim 1, wherein the first surfactant is described by one of the following general formulas: 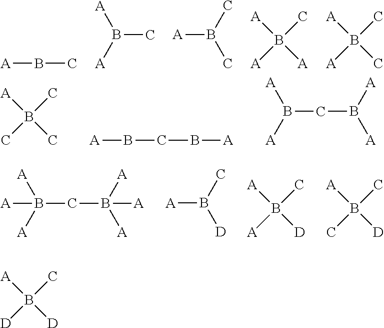
wherein:
A is an unsubstituted or substituted residue which carries an acid group or a deprotonated acid group;
B is an optional linker structure consisting of at least one atom or one chain;
C is a oligosilane residue or an oligosiloxane residue; and
D is an oligosiloxane residue.

7. The fire fighting foam concentrate according to claim 6, wherein C is described by one of the following formulas: 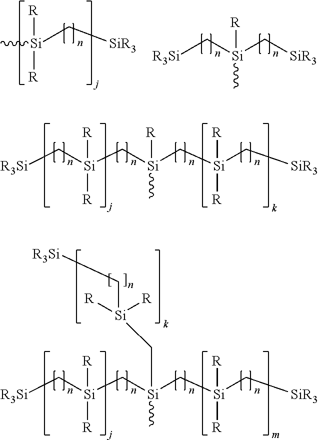
wherein each R is independently ethyl or methyl, n (each independently) represents 1, 2 or 3, and j, k, m are 1-9, wherein 1≦j+k+m≦10; 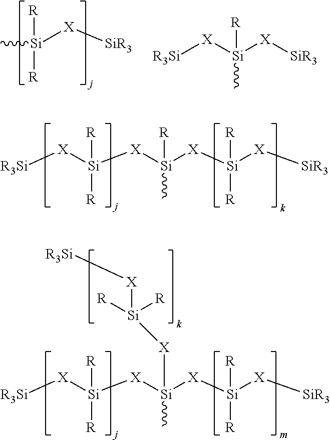
wherein each R is independently ethyl or methyl, each X is independently (CH₂)ₙ or O, wherein n (each independently) is 1, 2 or 3, and j, k, m are 1-9, where wherein 1≦j+k+m≦10; and 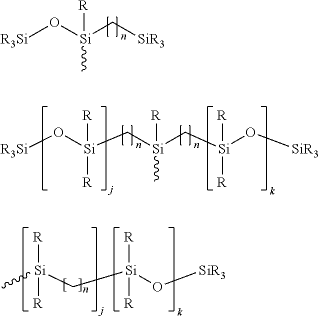
wherein each R is independently ethyl or methyl, each X is independently (CH₂)ₙ or O, wherein n (each independently) is 1, 2 or 3, and j, k are 1-9, wherein 1≦j+k≦10.

8. The fire fighting foam concentrate according to claim 1, wherein the first surfactant is selected from the following group: 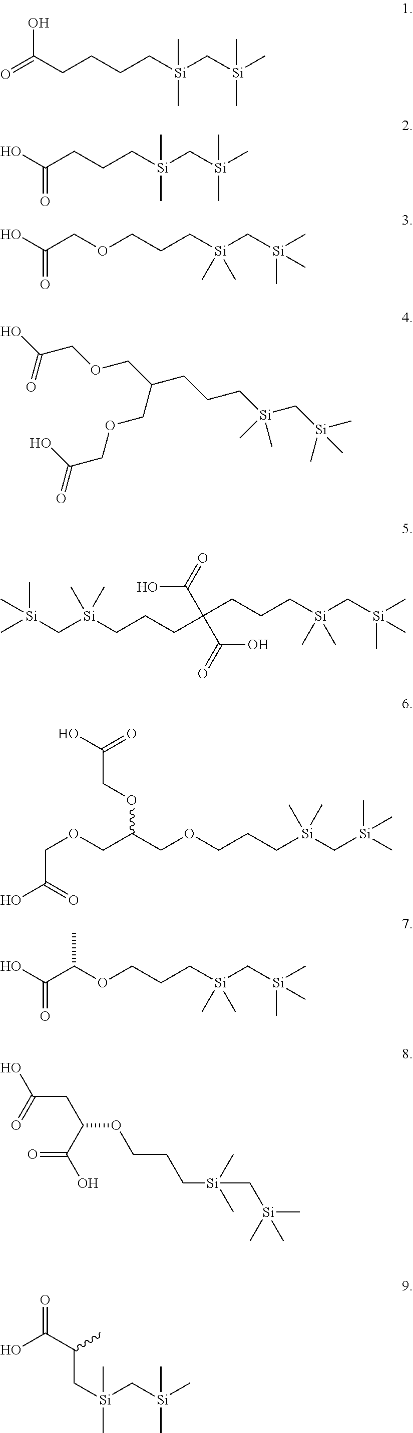 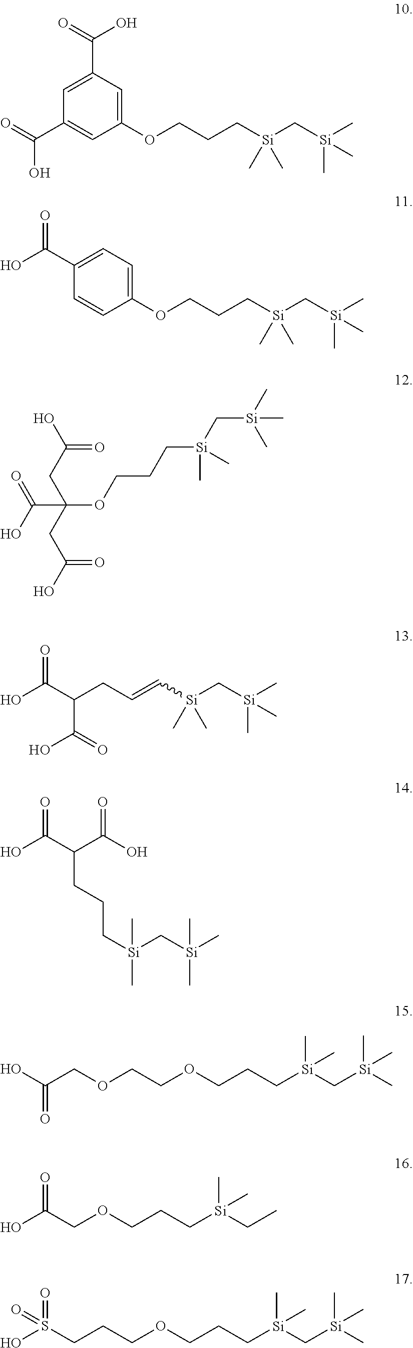 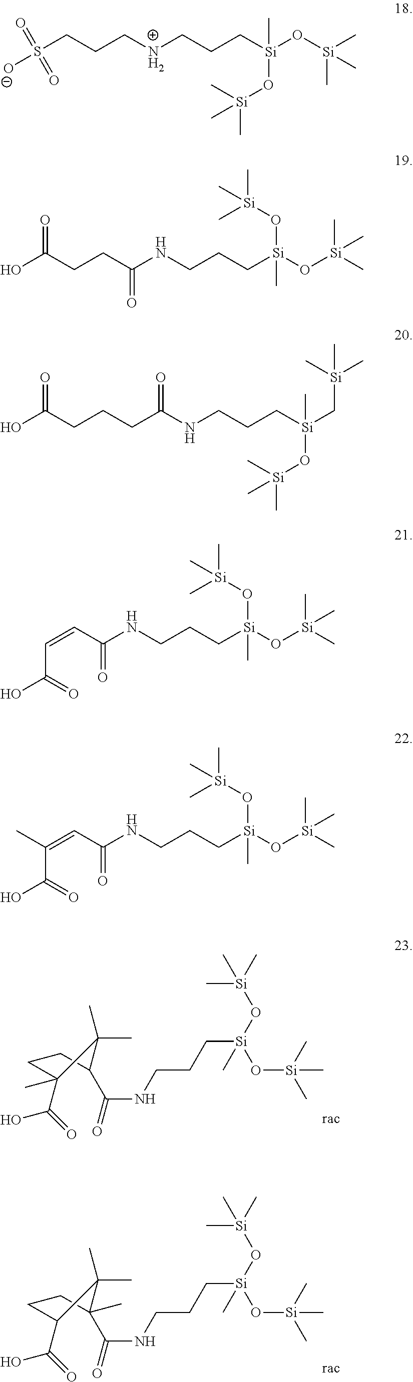
and/or salts of the aforementioned compounds.

9. A method for extinguishing fires, comprising the steps of:
providing a fire fighting foam concentrate;
adding the fire fighting foam concentrate to water in order to obtain a mixture;
contacting a fire site with the mixture;
characterized in that the fire fighting foam concentrate is a fire fighting foam concentrate according to claim 1.

10. Use of a surfactant as an additive to fire fighting foams and/or fire fighting foam concentrates, wherein the surfactant comprises an acid group and/or or a deprotonated acid group and an oligosilane unit and/or oligosiloxane unit.
